(19) United States
(12) Patent Application Publication
(10) Pub. No.: US 2009/0265665 A1
(43) Pub. Date: Oct. 22, 2009

(54) METHODS AND APPARATUS FOR INTERACTIVE ADVERTISING

(76) Inventor: Stephen Martiros, Sherborn, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/264,016

(22) Filed: Nov. 3, 2008

Related U.S. Application Data
(63) Continuation-in-part of application No. 12/104,278, filed on Apr. 16, 2008.

(51) Int. Cl. G06F 3/048

(52) U.S. Cl. 715/835

(57) ABSTRACT

Methods and apparatus for interactive advertising. A user may optionally select some or all of the interactive advertising for storage for later viewing or use. For example, in one embodiment, the user may have access to a personalized storage space for digital information and by, e.g., selecting a hyperlink, store the interactive advertising to the personalized storage space. The storage of particular advertisements can itself be used to select further advertisements, or may itself constitute valuable data that may be made available to advertisers or other third parties. For example, ad response rates, user feedback, and refined user model attributes may be provided to advertisers to facilitate subsequent marketing and ad delivery efforts. The selection of an advertisement may be used to influence the selection and display of subsequent advertisements to that particular user or to other similarly-characterized users as discussed below.

### CROSS-REFERENCE TO RELATED CASES

This application is a continuation-in-part of and claims priority to U.S. patent application Ser. No. 12/104,278, filed on Apr. 16, 2008, which is incorporated by reference as if set forth herein in its entirety.

### FIELD OF THE INVENTION

The present invention relates to methods and apparatus for interactive advertising, and in particular interactive user interface elements to present advertising to users of an electronic device.

### BACKGROUND OF THE INVENTION

Content and service providers typically enjoy several sources of revenue, such as revenue from subscriptions and revenue from advertising. Most advertising revenue is proportional to the number of viewer impressions, viewer transactions, etc., so a provider has a financial incentive to increase advertising revenue.

One method to increase advertising revenue is to make the advertising more prominent or attention getting. However, advertising that is too prominent can alienate users and actually reduce advertising revenue. One such example of over-prominent advertising on the Internet is “pop-over” ads, i.e., separate advertising windows displayed over a content window, whose very nature was so obnoxious that technology designed to block such ads is now standard in most major web browsers.

Accordingly, there is a need for methods and apparatus for interactive advertising that increase user impressions and user transactions without alienating users.

### SUMMARY OF THE INVENTION

Embodiments of the present invention provide methods and apparatus for interactive advertising. A user may optionally select some or all of the interactive advertising for storage for later viewing or use. For example, in one embodiment, the user may have access to a personalized storage space for digital information and by, e.g., selecting a hyperlink, store the interactive advertising to the personalized storage space. The storage of particular advertisements can itself be used to select further advertisements, or may itself constitute valuable data that may be made available to advertisers or other third parties. For example, ad response rates, user feedback, and refined user model attributes may be provided to advertisers to facilitate subsequent marketing and ad delivery efforts. The selection of an advertisement may be used to influence the selection and display of subsequent advertisements to that particular user or to other similarly-characterized users as discussed below.

In one aspect, embodiments of the present invention provide a method for interactive advertising. A plurality of user interface elements are presented, and an interactive user interface element is presented and placed so as not to obscure any of the plurality of user interface elements, said interactive user interface element being, for example, a graphical depiction of an envelope, a greeting card, a gift box, or other container or package. A selection of the interactive user interface element is received. In one embodiment, in response to the received selection, additional data associated with the interactive user interface element is presented.

In one embodiment, the plurality of user interface elements are presented graphically. In another embodiment, the received selection is a mouse-click. The additional data may be, for example, an advertisement or a video. In still another embodiment, the method further includes, in response to the received selection, storing data associated with the selected interactive user interface element, such as in storage for digital information.

In another aspect, embodiments of the present invention provide a user interface for interactive advertising. The interface includes a plurality of user interface elements, an interactive user interface element, and a receiver for receiving a selection of the interactive user interface element. The interactive element is, for example, a graphical depiction of an envelope, a greeting card, a gift box, or other container or package, and is placed so as not to obscure any of the plurality of user interface elements. Embodiments may optionally include a transmitter for presenting additional data associated with the interactive user interface element in response to the received selection.

In one embodiment, the user interface elements are graphic user interface elements. In another embodiment, the receiver is configured to receive mouse clicks. The additional data may be, for example, an advertisement or a video. In still another embodiment, the user interface also includes storage for digital information.

The foregoing and other features and advantages of the present invention will be made more apparent from the description, drawings, and claims that follow.

### BRIEF DESCRIPTION OF DRAWINGS

The advantages of the invention may be better understood by referring to the following drawings taken in conjunction with the accompanying description in which:

FIG. 1 is an illustration of a user interface composed of a plurality of user interface elements; and

FIG. 2 is a graphical depiction of the interface of FIG. 1 with an embodiment of an interactive user interface element 200 in accord with the present invention;

FIG. 2A is a graphical depiction of the interface of FIG. 1 with another embodiment of an interactive user interface element 250 in accord with the present invention;

FIG. 3 is a graphical depiction of the interactive user interface element 200 of FIG. 2 after its selection by a user;

FIG. 3A is a graphical depiction of the interactive user interface element 250 of FIG. 2A after its selection by a user;

FIG. 4 is a depiction of one example of additional data 204 presented in response to the selection of the element 200;

FIG. 4A is a depiction of one example of additional data 254 presented in response to the selection of the element 250;

FIG. 5 is an illustration of further additional data 208 presented in response to interaction with additional data 204;

FIG. 6 is a flowchart of an embodiment of a method for interactive advertising in accord with the present invention; and

FIG. 7 is a flowchart of an embodiment of a method for the selection of advertisements for interactive display.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

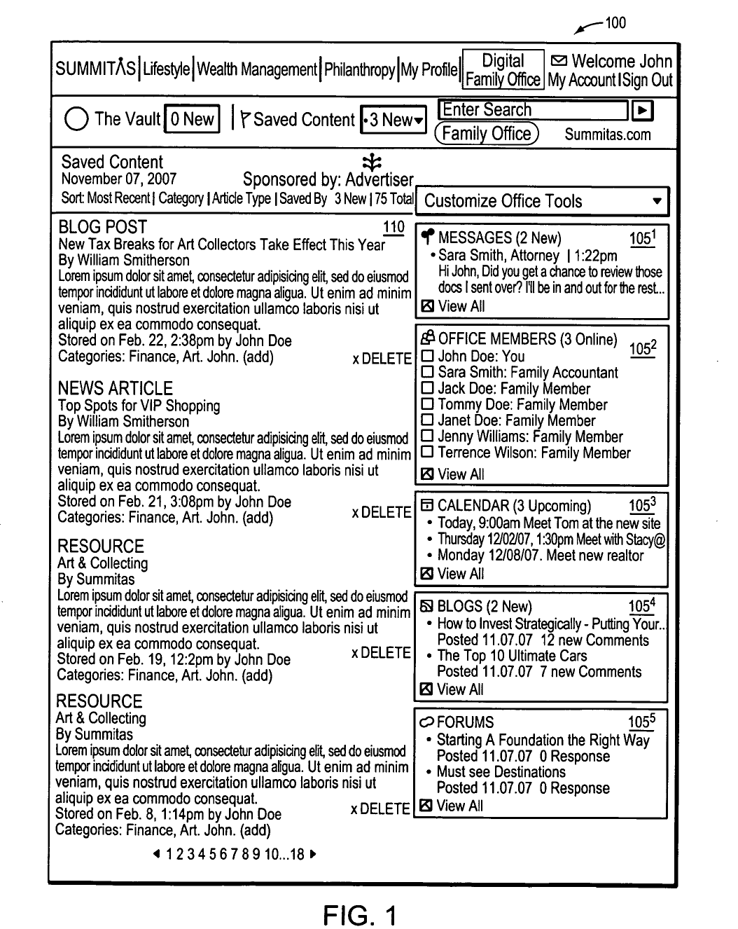

FIG. 1 presents a typical user interface 100, such as that experienced by a user operating a web browser executing on a computer. As presented, the interface 100 is composed of a plurality of graphic user interface elements 105ⁿ. Each user interface element 105 provides its own software-based functionality. The presented elements 105, which are merely exemplary and non-limiting, include a message box 105¹, a list of users actively using the service 105², a calendar 105³, a list of RSS feeds 105⁴, a list of public discussion groups 105⁵, etc. In the course of operating the computer, the user selects an element 105 using, e.g., a keyboard or a mouse, and thereby invokes its functionality.

FIG. 1 also includes a user interface element 110 that corresponds to content that has been selected by a user for storage to a private storage area. The element 110 organizes and displays the stored content for subsequent retrieval and utilization by an end user. Examples of content suitable for selection and storage include blog postings, documents, and web resources.

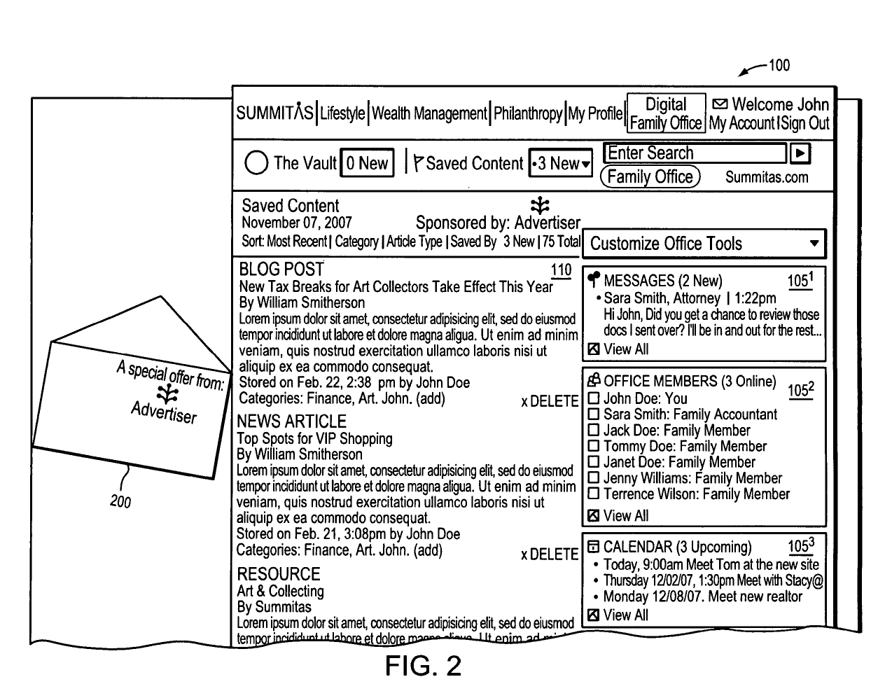

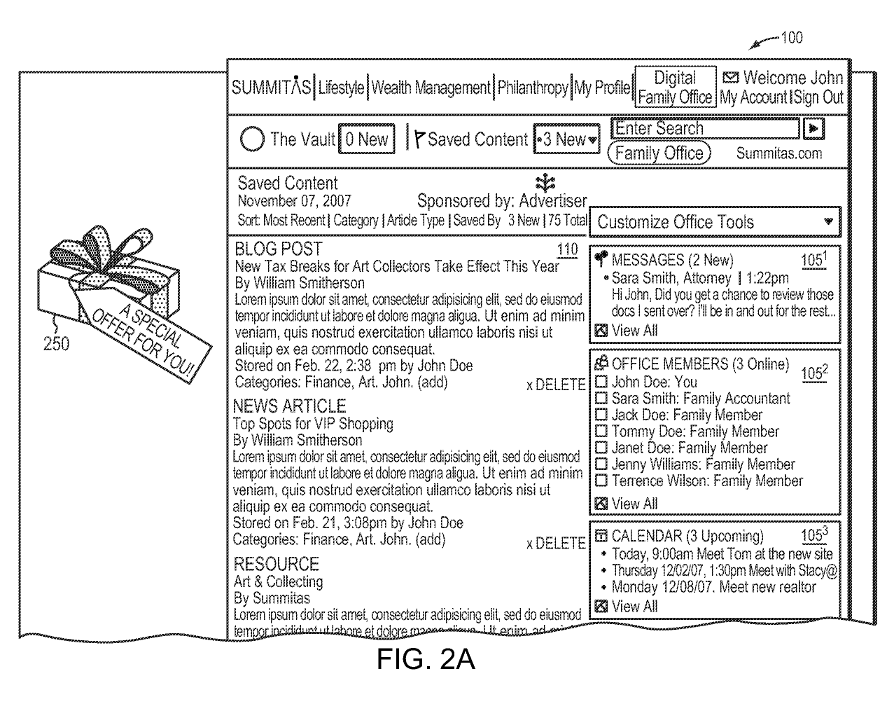

FIG. 2 presents one embodiment of a user interface in accord with the present invention. As depicted, FIG. 2 is identical to FIG. 1 save for the presentation of interactive user element 200 in the margin of the user interface. Element 200 is presented as a stylized depiction of an envelope, inviting the user to metaphorically open the envelope to obtain additional information. FIG. 2A presents another embodiment of the interactive user element 250, in this case a stylized depiction of a gift box, inviting the user to metaphorically open the gift box to obtain additional information. Other embodiments utilize other different, but analogous, user interface elements such as a greeting card, a container, a package, etc.

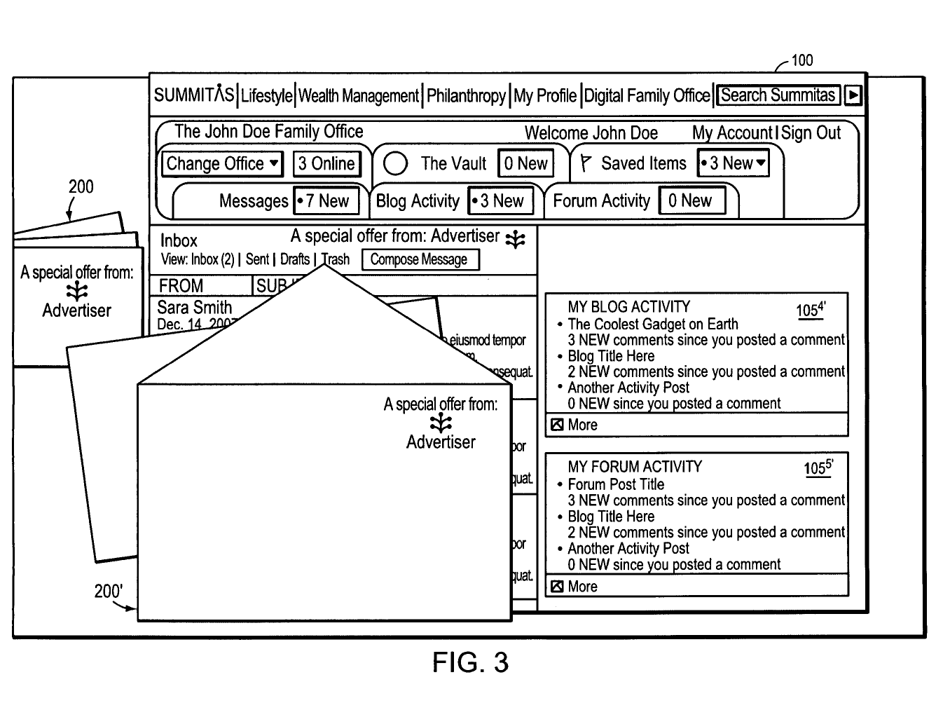

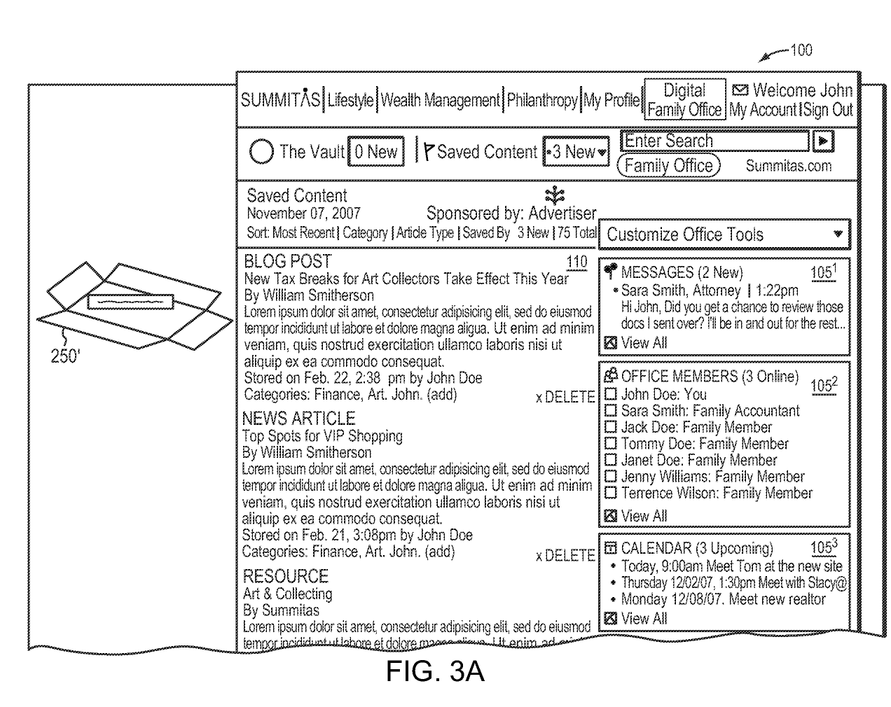

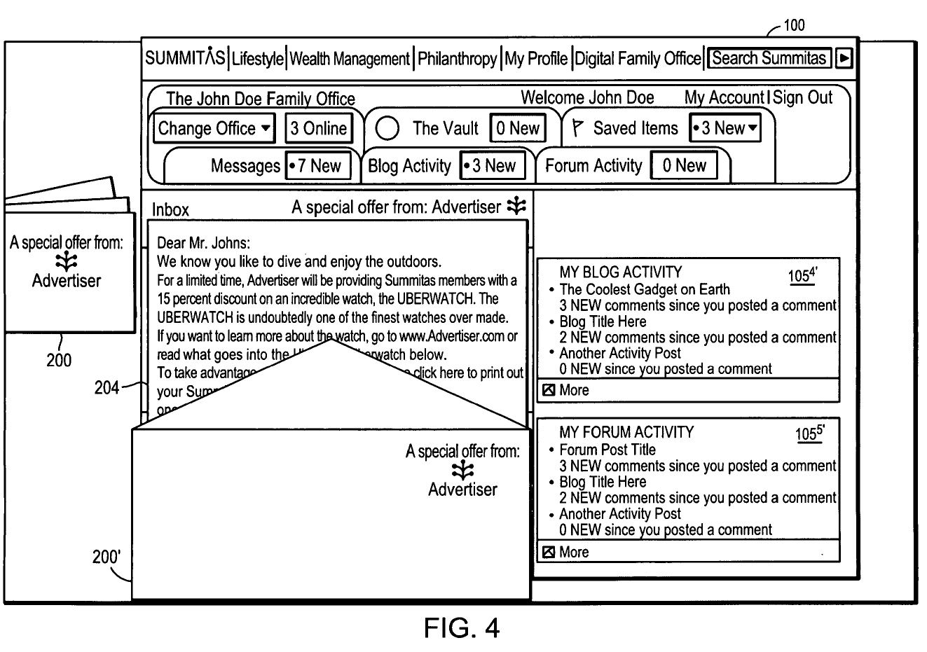

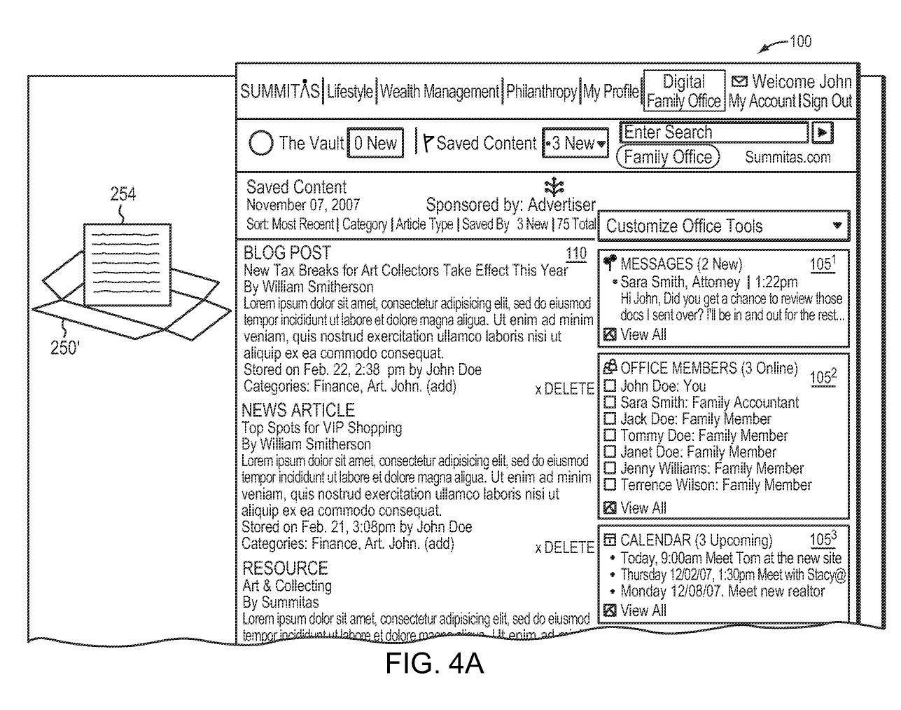

Referring now to FIGS. 3 and 3a, when a user of the interface 100 selects the interactive user interface element 200, 250 (in the same manner as any other element 105 is selected), the user interface element 200′, 250′ is animated and assumes a more prominent role in the interface 100. As depicted in FIG. 3, the animated user interface element may be placed in front of other user interface elements so as to attract a user's attention. As depicted in FIG. 3A, the animated user interface element may also be placed to the side of other user elements so as to not obscure those user interface elements. With reference to FIGS. 4 and 4a, when the animated element 200′, 250′ is properly positioned, additional data 204, 254 related to the interactive user interface element 200, 250 is presented to the user. This allows for the presentation of, e.g., more detailed advertising information or videos to interested users. In the exemplary embodiments of FIGS. 4 and 4a, the additional data 204, 254 includes a customized text message having embedded hyperlinks.

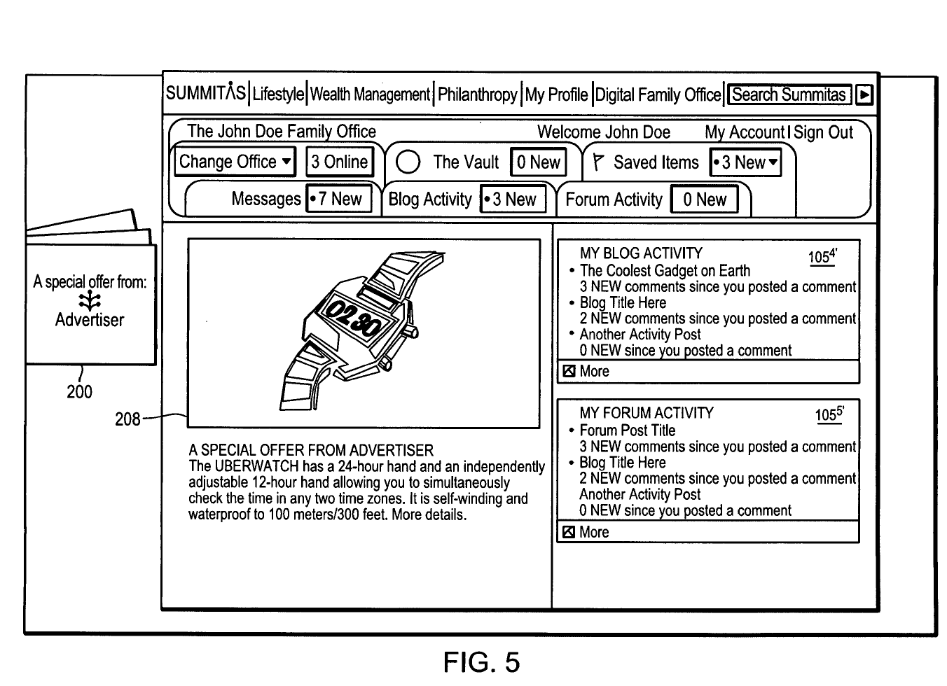

Such an interactive user interface element 200, 250 may be implemented using, for example, FLASH technology from Adobe Systems of San Jose, Calif. or SILVERLIGHT technology from Microsoft Corporation of Redmond, Wash. The presentation of additional data 204, 254 may itself allow the user to elect the receipt of further additional data 208, so that, e.g., initial detailed advertising information may itself chain to, e.g., a video presentation. In one embodiment, the additional data 208 allows a user to navigate to a selected third party website. FIG. 5 presents an exemplary embodiment where the further additional data 208 is a graphical advertisement for a product.

The content for the advertisement provided by the user interface element 200, 250 may be selected using, for example, data associated with a user's profile (such as past advertisements viewed or selected), website content viewed or saved by a user, or a user's responses to survey questions. This information may be collected and processed. Such processing includes but is not limited to categorization by attributes, quantification according to metric ranges, and chronological organization. Once processed, the processed information may be used to select a particular advertisement by matching the processed information against tags associated with the advertisements and presenting a particular advertisement having tags matching the processed data.

The tags associated with a particular advertisement may be specified by the advertiser or automatically suggested based on the characteristics associated with the user models of those users choosing to view the advertisement. This process may be iterative, allowing for the specification of additional tags or refinement of the existing tags associated with an advertisement as advertisements are delivered, thereby improving the targeted delivery of advertisements to users.

Once viewed by a user, the user may optionally select some or all of the content provided by the user interface element 200, 250 to storage for later viewing or use. For example, in one embodiment, the user may have access to a personalized storage space for digital information and by, e.g., selecting a hyperlink, store the content associated with the user interface element 200, 250 to the personalized storage space. The storage of particular advertisements can itself be used to select further advertisements, as discussed above, or may itself constitute valuable data that may be made available to advertisers or other third parties. For example, ad response rates, user feedback, and refined user model attributes may be provided to advertisers to facilitate subsequent marketing and ad delivery efforts. The selection of an advertisement per se may be used to influence the selection and display of subsequent advertisements to that particular user or to other similarly-characterized users as discussed below.

In one embodiment, the selection of particular advertisements is related to the user model associated with the user selecting the advertisement. This relationship allows for the identification and selection of other user models similar to the identified user model, allowing for the targeted delivery of advertisements. That is, assuming that the user model of the user selecting the advertisements accurately describes those characteristics of the user that make the selected advertisement interesting to the user, identifying users having those same characteristics in their user models suggests that the selected advertisement would be interesting to those users as well.

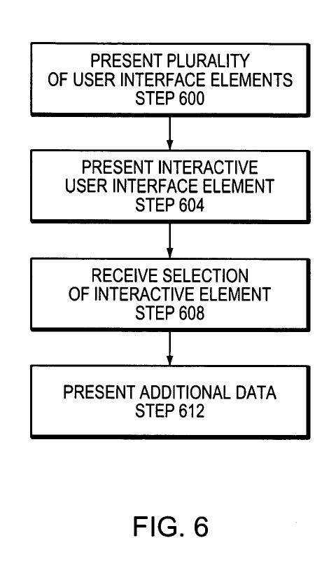

FIG. 6 is a flowchart presenting an embodiment of a method for interactive advertising. A plurality of user interface elements are presented (Step 600). An interactive user interface element is presented (Step 604), the interactive element being, for example, a graphical depiction of an envelope, a greeting card, a gift box, or other container or package placed so as not to obscure any of the plurality of user interface elements. A selection of the interactive user interface element is received (Step 608) and, in response to the received selection, additional data is presented associated with the interactive user interface element (Step 612).

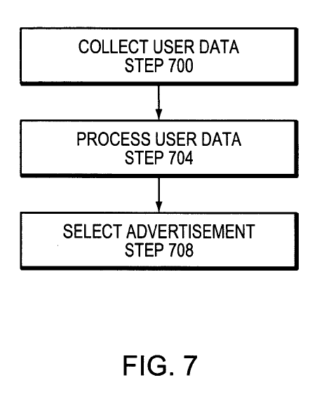

FIG. 7 is a flowchart presenting an embodiment of a method for selecting advertisements for interactive display. Data concerning a user, such as the user's profile data, web history, or survey responses is collected (Step 700). This data is then processed (Step 704), including but not limited to categorizing the data by attributes, quantifying the data according to metric ranges, and placing the data in time order. An advertisement is selected (Step 708) by matching the processed information against tags associated with a set of advertisements and selecting a particular advertisement whose tags match the processed data. Once the advertisement is selected, it can be presented to the user using embodiments of the systems and methods described above.

It will therefore be seen that the foregoing represents a highly advantageous approach to interactive advertising. The terms and expressions employed herein are used as terms of description and not of limitation and there is no intention, in the use of such terms and expressions, of excluding any equivalents of the features shown and described or portions thereof, and it is recognized that various modifications are possible within the scope of the invention claimed.

What is claimed is:

1. A method for interactive advertising, the method comprising:
presenting a plurality of user interface elements;
presenting an interactive user interface element, said interactive element placed so as not to obscure any of the plurality of user interface elements, said interactive element being a graphical depiction selected from the group consisting of graphical depictions of an envelope, a greeting card, a gift box, a container, and a package; and
receiving a selection of the interactive user interface element.

2. The method of claim 1 further comprising, in response to the received selection, presenting additional data associated with the interactive user interface element.

3. The method of claim 2 wherein the additional data is an advertisement.

4. The method of claim 2 wherein the additional data is a video.

5. The method of claim 1 wherein the plurality of user interface elements are presented graphically.

6. The method of claim 1 wherein the selection is a mouse click.

7. The method of claim 1 further comprising, in response to the received selection, storing data associated with the selected interactive user interface element.

8. The method of claim 1 further comprising, in response to the received selection, storing data associated with the selected interactive user interface element in storage for digital information.

9. A user interface for interactive advertising, the user interface comprising:
a plurality of user interface elements;
an interactive user interface element, said interactive element placed so as not to obscure any of the plurality of user interface elements, said interactive element being a graphical depiction selected from the group consisting graphical depictions of an envelope, a greeting card, a gift box, a container and a package; and
a receiver for receiving a selection of the interactive user interface element.

10. The user interface of claim 9 further comprising a transmitter for presenting additional data associated with the interactive user interface element in response to the received selection.

11. The user interface of claim 9 wherein the user interface elements are graphic user interface elements.

12. The user interface of claim 9 wherein the receiver is configured to receive mouse clicks.

13. The user interface of claim 9 wherein the additional data is an advertisement.

14. The user interface of claim 9 wherein the additional data is a video.

15. The user interface of claim 9 further comprising storage for digital information.
